(19) United States
(12) Patent Application Publication
(10) Pub. No.: US 2026/0062023 A1
(43) Pub. Date: Mar. 5, 2026

(54) Surround view monitoring that facilitates autonomous parking of vehicle

(71) Applicant: Atieva, Inc., Newark, CA (US)

(72) Inventors: Eui Chan Choi, San Jose, CA (US); Juan Pineda Hernandez, Fremont, CA (US); Rodrigo Cardenas Islas Bustamante, Fremont, CA (US); Venkata Phani Ram Janardhan Sunku, Newark, CA (US); Chaoyi Xu, Fremont, CA (US); Yunwei Yang, Foster City, CA (US)

(21) Appl. No.: 18/821,464

(22) Filed: Aug. 30, 2024

(51) Int. Cl. B60W 50/14; B60K 35/28; B60W 30/06; G06T 3/4038

(52) U.S. Cl. CPC B60W 50/14; B60K 35/28; B60W 30/06; G06T 3/4038; B60K 2360/11; B60K 2360/171; B60K 2360/176; B60W 2050/146; B60W 2420/403; B60W 2420/54; B60W 2540/215

(57) ABSTRACT

A method comprises: receiving a surround view monitoring (SVM) video feed from SVM cameras of a vehicle; identifying, using the SVM video feed and a signal from one or more ultrasonic sensors of the vehicle, a first parking slot that is available for parking the vehicle, the first parking slot associated with coordinates; overlaying, using the coordinates of the first parking slot, a first graphic on the SVM video feed to generate an augmented SVM video feed, the first graphic representing the first parking slot; and presenting the augmented SVM video feed including the graphic on a display device of the vehicle, wherein the first graphic is selectable by a user to trigger an autonomous parking maneuver of the vehicle into the first parking slot, and wherein the augmented SVM video feed facilitates freeform perspective change by the user.

### TECHNICAL FIELD

This disclosure relates to surround view monitoring that facilitates autonomous parking of a vehicle.

### BACKGROUND

Some modern vehicles use cameras mounted on the vehicle body to monitor the surroundings. Typically, video is presented on a display device in the passenger compartment. Recently, some vehicle manufacturers have begun offering autonomous parking functionality as a form of driver assistance. However, these approaches to facilitate autonomous parking may suffer because they provide a fragmented experience, lack interaction, may have unreliable accuracy, or lack compelling immersion for the user.

### SUMMARY

In a first aspect, a method comprises: receiving a surround view monitoring (SVM) video feed from SVM cameras of a vehicle; identifying, using the SVM video feed and a signal from one or more ultrasonic sensors of the vehicle, a first parking slot that is available for parking the vehicle, the first parking slot associated with coordinates; overlaying, using the coordinates of the first parking slot, a first graphic on the SVM video feed to generate an augmented SVM video feed, the first graphic representing the first parking slot; and presenting the augmented SVM video feed including the graphic on a display device of the vehicle, wherein the first graphic is selectable by a user to trigger an autonomous parking maneuver of the vehicle into the first parking slot, and wherein the augmented SVM video feed facilitates freeform perspective change by the user.

Implementations can include any or all of the following features. The SVM cameras generate fishbowl views, the method further comprising unwarping the SVM video feed and performing stitching to generate frames of the SVM feed. The method further comprises performing the autonomous parking maneuver in response to the user selecting the first graphic. Also a second parking slot is identified using the SVM video feed and the signal from the one or more ultrasonic sensors. The method further comprises overlaying also a second graphic on the SVM video feed to generate the augmented SVM video feed, the second graphic representing the second parking slot, wherein the second graphic is selectable by the user to trigger the autonomous parking maneuver of the vehicle into the second parking slot. The method further comprises removing the second graphic from the augmented SVM video feed in response to the user selecting the first graphic. The method further comprises prioritizing, before overlaying the first graphic on the SVM video feed, the first parking slot over the second parking slot, wherein as a result the second parking slot is not presented to the user. The method further comprises overlaying also a motion path graphic on the SVM video feed to generate the augmented SVM video feed. The motion path graphic includes an end line regarding the autonomous parking maneuver. The motion path graphic indicates a trajectory of the autonomous parking maneuver. The method further comprises, at an end of the autonomous parking maneuver, overlaying also a third graphic on the SVM video feed to generate the augmented SVM video feed, the third graphic representing at least one of a door swing path of travel for the vehicle, or a wheel position of the vehicle. The method further comprises presenting a control for the user to choose whether the vehicle enters the first parking slot front-first or rear-first in the autonomous parking maneuver. The method further comprises overlaying also a vehicle graphic on the SVM video feed to generate the augmented SVM video feed, the vehicle graphic representing the vehicle. The method further comprises automatically providing, during the autonomous parking maneuver, contextual views using the freeform perspective change, the contextual views depending on gear change of the vehicle. The first graphic is a rectangle corresponding to the first parking slot. The first graphic is a symbol representing the first parking slot.

In a second aspect, a non-transitory computer-readable medium including instructions that when executed cause a processor to perform operations, the operations comprising: receiving a surround view monitoring (SVM) video feed from SVM cameras of a vehicle; identifying, using the SVM video feed and a signal from one or more ultrasonic sensors of the vehicle, a first parking slot that is available for parking the vehicle, the first parking slot associated with coordinates; overlaying, using the coordinates of the first parking slot, a first graphic on the SVM video feed to generate an augmented SVM video feed, the first graphic representing the first parking slot; and presenting the augmented SVM video feed including the graphic on a display device of the vehicle, wherein the first graphic is selectable by a user to trigger an autonomous parking maneuver of the vehicle into the first parking slot, and wherein the augmented SVM video feed facilitates freeform perspective change by the user.

In a third aspect, a non-transitory computer-readable medium including instructions that when executed cause a processor to generate a graphical user interface (GUI) for a vehicle, the GUI presented on a display device of the vehicle and comprising: an augmented surround view monitoring (SVM) video feed based on an SVM video feed from SVM cameras of the vehicle, the augmented SVM video feed including a first graphic representing a first parking slot that is available for parking the vehicle, the first parking slot identified using the SVM video feed and a signal from one or more ultrasonic sensors of the vehicle, wherein the first graphic is selectable by a user to trigger an autonomous parking maneuver of the vehicle into the first parking slot, and wherein the augmented SVM video feed facilitates freeform perspective change by the user.

Implementations can include any or all of the following features. Also a second parking slot is identified using the SVM video feed and the signal from the one or more ultrasonic sensors, and wherein also a second graphic on the SVM video feed to generate the augmented SVM video feed, the second graphic representing the second parking slot, wherein the second graphic is selectable by the user to trigger the autonomous parking maneuver of the vehicle into the second parking slot. The GUI automatically provides contextual views using the freeform perspective change, the contextual views depending on gear change of the vehicle.

### BRIEF DESCRIPTION OF DRAWINGS

FIG. 1 shows an example of views that can be presented on one or more display devices of a vehicle.

FIG. 2 shows another example of the view of FIG. 1 where the user has initiated an auto park process.

FIG. 3 shows another example of the view of FIG. 1 where parking spaces have been detected.

FIGS. 4, 5 and 6 show examples of freeform perspective changes of the view of FIG. 1.

FIG. 7 shows an example of an autonomous parking maneuver of the vehicle.

FIG. 8 shows an example of the autonomous parking maneuver having been completed.

FIG. 9 shows an example of an instrument panel of a vehicle.

FIG. 10 shows an example of a vehicle with a system for distributing signals to and/or from multiple controllers.

FIG. 11 shows an example of contextual views.

FIG. 12 shows another example of contextual views.

FIG. 13 shows another example of a vehicle.

FIG. 14 illustrates an example architecture of a computing device that can be used to implement aspects of the present disclosure.

Like reference symbols in the various drawings indicate like elements.

### DETAILED DESCRIPTION

This document describes examples providing a seamless experience for a vehicle user in searching for available parking spaces and autonomously parking the vehicle, using real-time visualization in a 360-degree camera surround view monitoring (SVM) system. The present subject matter can unify 360-degree cameras to provide both SVM and auto park. A feed from 360-degree SVM cameras can be merged with an auto park feature into a unified application to make a real-time event of an auto park active guidance maneuver. The user can interact with the camera view and change the perspective of the surroundings. Contextual camera movements can be provided that automatically change camera perspective based on autonomous gear change. In some implementations, this can ensure that the best viewing experience is provided for each auto park maneuver. For example, detection of potential obstructions or blind spots can be improved.

Examples described herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle. Vehicles in the present examples are illustrated as being similar or identical to each other for illustrative purposes only.

Examples described herein refer to a display device. As used herein, a display device includes any device that can present visual output generated by one or more processors. In some implementations, a display device visually outputs a graphical user interface for one or more computer devices. A display device can operate according to any of multiple display technologies used for presenting computer-based information. A display device can include a liquid crystal display (LCD), a light-emitting diode (LED) display, and/or a plasma display, to name just a few examples. A display device can be configured for receiving input for the computer device(s). In some implementations, a display device can feature one or more types of technology for detecting contact with, or proximity to, the screen by a user's hand or an implement such as a stylus. A display device can operate according to any of multiple touch-detecting, or gesture-recognizing, technologies. A display device can include a resistive touchscreen, a capacitive touchscreen, and/or a touchscreen based on optical imaging, to name just a few examples. A display device can have any of multiple shapes. In some implementations, a display device has a quadrilateral shape (e.g., rectangular), or a non-polygonal shape, to name just a few examples. A display device can have a substantially flat form factor (e.g., the screen is essentially planar), or a non-flat form factor (e.g., the screen is curved according to one or more radiuses.) Two or more display devices can be positioned according to any of multiple spatial relationships with regard to each other.

Examples described herein refer to an ADAS. Assisted driving involves at least partially automating one or more dynamic driving tasks by way of computer-based operations (e.g., by a processor executing instructions). An ADAS can perform assisted driving and is an example of an assisted-driving system. Assisted driving is performed based in part on the output of one or more sensors typically positioned on, under, or within the vehicle, which is sometimes referred to as the ego vehicle. An ADAS can plan one or more trajectories for a vehicle before and/or while controlling the motion of the vehicle. A planned trajectory can define a path for the vehicle's travel. As such, propelling the vehicle according to the planned trajectory can correspond to controlling one or more aspects of the vehicle's operational behavior, such as, but not limited to, the vehicle's steering angle, gear (e.g., forward or reverse), speed, acceleration, and/or braking. As used herein, an ADAS controller is a processor-based device that performs one or more ADAS functions in a vehicle. For example, the ADAS controller can be referred to as an electronic control unit (ECU) of the vehicle.

While an autonomous vehicle is an example of a system that performs assisted driving, not every assisted-driving system is designed to provide a fully autonomous vehicle. Several levels of driving automation have been defined by SAE International, usually referred to as Levels 0, 1, 2, 3, 4, and 5, respectively. For example, a Level 0 system or driving mode may involve no sustained vehicle control by the system. For example, a Level 1 system or driving mode may include adaptive cruise control, emergency brake assist, automatic emergency brake assist, lane-keeping, and/or lane centering. For example, a Level 2 system or driving mode may include highway assist, autonomous obstacle avoidance, and/or autonomous parking. For example, a Level 3 or 4 system or driving mode may include progressively increased control of the vehicle by the assisted-driving system. For example, a Level 5 system or driving mode may require no human intervention of the assisted-driving system.

Examples described herein refer to an infotainment controller. As used herein, an infotainment controller is a processor-based device in a vehicle that performs one or more functions involving infotainment, media, navigation, communication, or vehicle control, or combinations thereof. Infotainment can refer to the human-machine interface for a passenger to interact with the computer(s) of the vehicle. The infotainment controller can provide a graphical user interface, such as supported by touchscreen input technology, keys, and/or voice recognition. The infotainment controller can be referred to as an electronic control unit of the vehicle (e.g., for a front occupant media system).

Examples herein refer to a sensor. A sensor is configured to detect one or more aspects of its environment and output signal(s) reflecting the detection. The detected aspect(s) can be static or dynamic at the time of detection. As illustrative examples only, a sensor can indicate one or more of a distance between the sensor and an object, a speed of a vehicle carrying the sensor, a trajectory of the vehicle, or an acceleration of the vehicle. A sensor can generate output without probing the surroundings with anything (passive sensing, e.g., like an image sensor that captures electromagnetic radiation), or the sensor can probe the surroundings (active sensing, e.g., by sending out electromagnetic radiation and/or sound waves) and detect a response to the probing. Examples of sensors that can be used with one or more embodiments include, but are not limited to: a light sensor (e.g., a camera); a light-based sensing system (e.g., a light ranging and detection (LiDAR) device); a radio-based sensor (e.g., radar); an acoustic sensor (e.g., an ultrasonic device and/or a microphone); an inertial measurement unit (IMU) (e.g., a gyroscope and/or accelerometer); a speed sensor (e.g., for the vehicle or a component thereof); a location sensor (e.g., for the vehicle or a component thereof); an orientation sensor (e.g., for the vehicle or a component thereof); a torque sensor; a thermal sensor; a temperature sensor (e.g., a primary or secondary thermometer); a pressure sensor (e.g., for ambient air or a component of the vehicle); a humidity sensor (e.g., a rain detector); or a seat occupancy sensor.

Examples described herein refer to a camera. As used herein, a camera includes any image sensor that captures electromagnetic radiation. A camera can be used for SVM and/or other imaging. An SVM camera can have a significantly wider field of view (FOV) than another camera that is also part of the perception sensors for a driver assistance system of the vehicle.

Examples herein refer to a parking slot. As used herein, a parking space, a parking spot, or a parking slot are different words for the same thing. A parking slot includes any location that can be identified as a place to render a vehicle stationary, regardless of the duration of the stay. The parking slot can be, but is not necessarily, defined by one or more markings or structure on the surface on which the vehicle sits. A parking slot can be located on public property or on private property. A parking slot can be located on developed land or on undeveloped land. A parking slot can be located at least partially within a structure or can be located away from any structures. A parking slot can be located inside a building or in open air. A parking slot can be located adjacent a roadway (e.g., street, avenue, or road) or can be located on premises that are set off from at least one roadway. When the parking slot is located adjacent a roadway, the roadway can have one or more lanes. When the parking slot is located adjacent a roadway, the roadway can be restricted to one-way travel (e.g., a one-way street), or can allow two-way traffic. A parking slot can be characterized as being oriented parallel with, or perpendicular to, an adjacent roadway, to name just two examples. A parking slot can be subject to parking regulations by a government and/or private entity. A parking slot can be subject to monitoring by human personnel and/or automated devices, or the parking slot can be unmonitored. A parking slot can be permanent or temporary. A parking lot is a location that includes two or more parking slots.

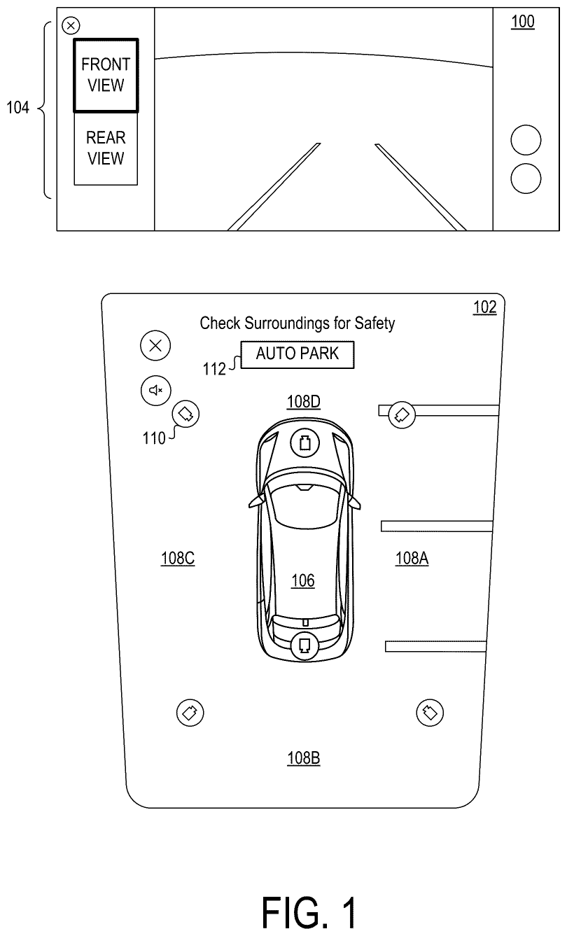

FIG. 1 shows an example of views 100 and 102 that can be presented on one or more display devices of a vehicle. In some implementations, the views 100-102 are presented by an interactive multi-display SVM system. Here, the view 100 includes a camera feed that can be either a front view or a rear view from the vehicle. In some implementations, the view 100 presents a touchscreen input control 104. The touchscreen input control 104 can be used for choosing among (e.g., toggling between) the outputs from the cameras. For example, the view 100 currently presents a front view captured by a front camera of the vehicle.

The system can receive outputs from at least four cameras (e.g., aimed in respective different directions from the vehicle). The SVM system can stitch together the outputs into an image. An image processing component can perform unwarping and stitch together the outputs into the view 102. Here, the view 102 shows a top-down view of a vehicle 106. Also shown in the view 102 are surroundings of the vehicle 106 including a right side 108A, a rear side 108B, a left side 108C, and a front side 108D. The vehicle 106 can be a three-dimensional (3D) model representing the vehicle that has the SVM system and for which the views 100-102 are generated.

The views 100-102 can be simultaneously presented in the vehicle. For example, the view 100 is presented at a display device (e.g., an instrument cluster) at the same time as the view 102 is presented at another display device (e.g., a center display). This can provide the advantage to the driver of being able to see both a surrounding view (e.g., a construed or composite representation) and a direct view (e.g., an unaltered output from one or the vehicle's cameras) at the same time, while being able to initiate an autonomous parking maneuver.

The view 102, which can be referred to as an augmented image due to at least having been stitched from respective images and including the 3D model, can include one or more touchscreen controls. Here, the view 102 includes multiple view presets 110. Actuating one of the view presets 110 can trigger the interactive multi-display SVM system to change the view 102 in one or more ways. For example, the view 102 can be changed to a perspective view.

The view 102 can be shown in response to the user initiating a parking application executed by the vehicle. For example, the parking application can ensure that the views 100-102 (or another SVM view) are shown, to aid the user in parking the vehicle. The vehicle and the parking application can support autonomous parking by an ADAS. Here, a control 112 is labeled “auto park” and can be used to initiate a search for available parking spaces near the vehicle.

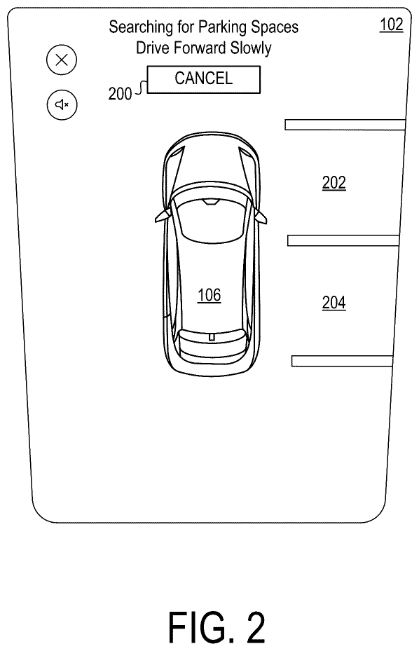

FIG. 2 shows another example of the view 102 of FIG. 1 where the user has initiated an auto park process. The view 102 now indicates that the system is searching for parking spaces. The view 102 can instruct the user to drive forward slowly as part of the search. For example, the search can be performed using one or more sensors (e.g., SVM cameras and/or an ultrasonic sensor). A control 200 can allow the user to cancel the search for parking spaces.

The searching has here not yet identified any sparking space(s) to the user. However, the present illustration reveals that a parking slot 202 and a parking slot 204 are located adjacent the vehicle 106 and may become candidates for available parking spaces.

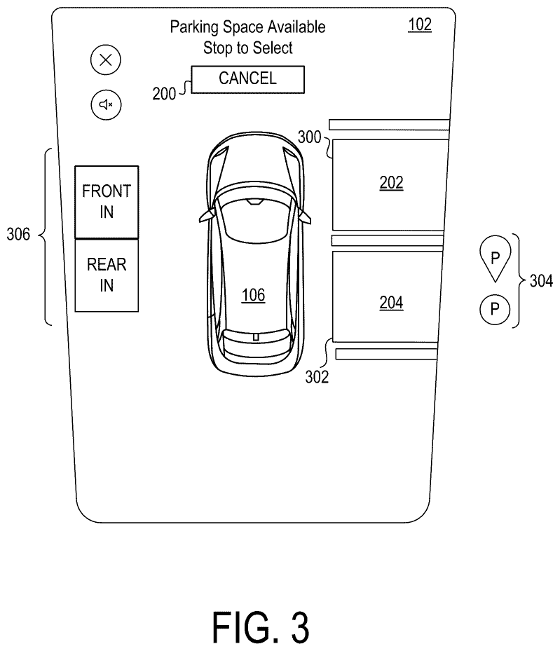

FIG. 3 shows another example of the view 102 of FIG. 1 where parking spaces have been detected. The view 102 now indicates to the user that parking space is available. Here, the view 102 has been updated to overlay additional graphics that represent the detection of parking spaces. A graphic 300 indicates that the parking slot 202 has been identified as an available parking slot. A graphic 302 indicates that the parking slot 204 has been identified as an available parking slot. The search may have been performed using one or more sensors (e.g., SVM cameras and/or an ultrasonic sensor).

The graphics 300-302 illustrate that a rectangle (or other polygonal shape) can be overlaid on an SVM feed to indicate an identified parking slot. A symbol can be used instead or additionally. Here, graphics 304 are schematically illustrated and show a symbol having droplet shape and a symbol having a circular shape, both labeled with P for parking, to name a few examples. The graphics 304 can be used instead of, or together with, either or both of the graphics 300-302, to name just a few examples.

The view 102 can facilitate user selection of any parking slot that is currently indicated as available. In some implementations, the system instructs the user to stop the vehicle (e.g., bring the vehicle to a standstill) before making a selection. In some implementations, the view 102 is presented on a touch-sensitive display device and one or more gestures can be recognized as a selection or other input. For example, the user can tap on either of the graphics 300-302 to make a selection for an autonomous parking maneuver. The system can present a control 306 for the user to choose whether to enter the parking slot front-first (here “front in”) or rear-first (here “rear in”) in the autonomous parking maneuver.

The system can perform prioritization among two or more identified parking slots. For example, if both of the parking slots 202-204 have been identified as being available, the system can decide, by applying prioritization criteria, whether to offer the parking slot 202, or the parking slot 204, or both, to the user for selection. One or more parking slots that have been identified may therefore not be presented to the user as a result of the prioritization.

Before committing to a particular parking spot the user may wish to evaluate the surroundings. The view 102 can facilitate freeform perspective change by way of altering the SVM perspective from which the user sees the vehicle 106 and/or the near environment of the vehicle 106. Some examples will now be provided.

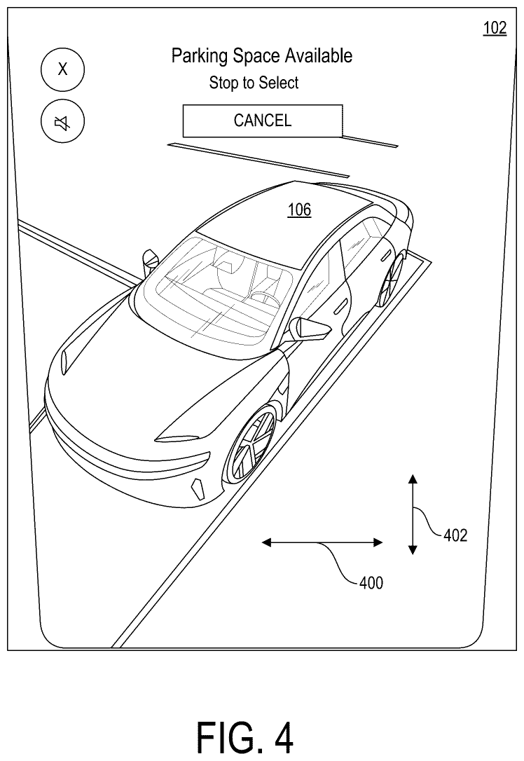

FIGS. 4, 5 and 6 show examples of freeform perspective changes of the view of FIG. 1. In these illustrations, the user has continued to drive the vehicle some distance from the location shown in the previous examples. In FIG. 4, the view 102 shows a perspective view where the vehicle 106 is seen at an askew angle from the front and somewhat from the above. For example, the user can choose any of a continuous range of SVM perspectives using a gesture 400 (e.g., a horizontal swipe on the touchscreen) or a gesture 402 (e.g., a vertical swipe on the touchscreen) or combinations thereof. Preset views may also or instead be used. The view 102 that is being shown as a result of the freeform perspective change is stitched together from the video feeds of multiple SVM cameras. As such, the user can seamlessly change the perspective to view the surroundings from any angle. For example, this allows the user to better evaluate the available parking slot(s).

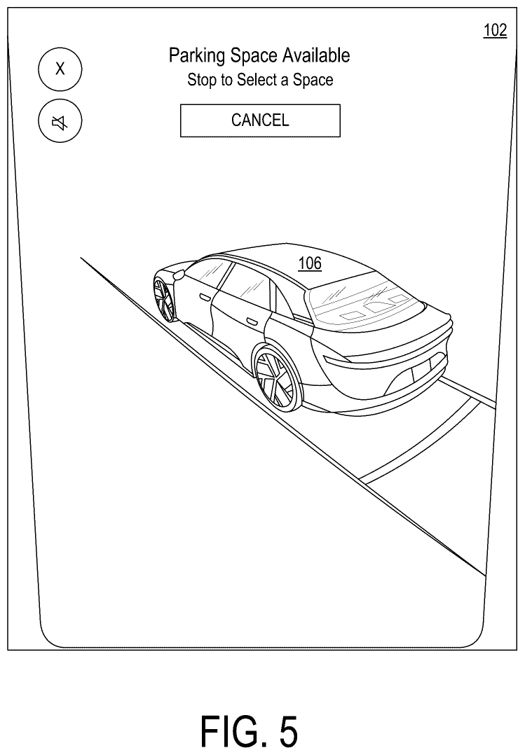

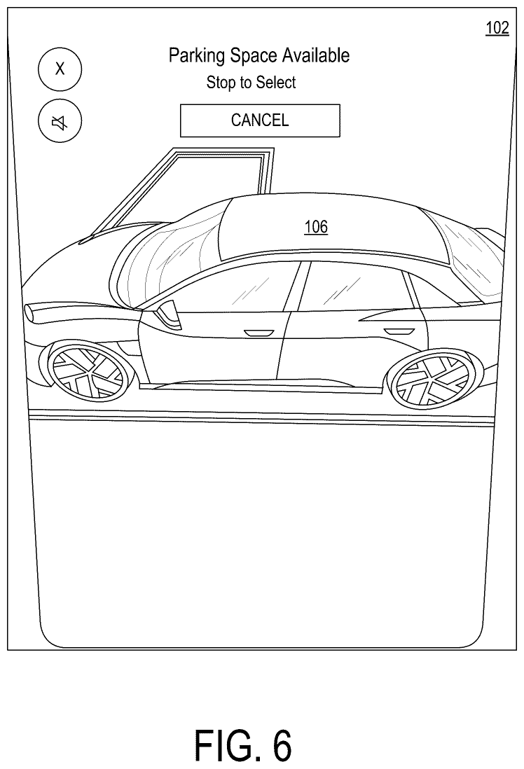

Additional user input can be made to choose another freeform perspective. In FIG. 5, the view 102 shows a perspective view where the vehicle 106 is seen at an askew angle from the rear and somewhat from the above. In FIG. 6, the view 102 shows a perspective view where the vehicle 106 is seen from the side and somewhat from the above. As such, the user can evaluate the parking situation from two or more different SVM perspectives to consider their parking options. Other freeform perspectives can be chosen.

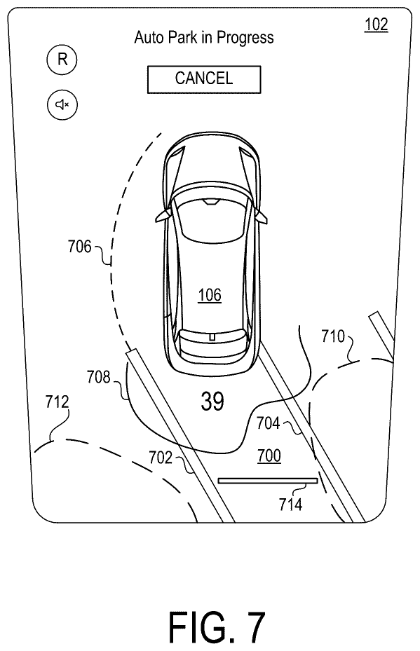

FIG. 7 shows an example of an autonomous parking maneuver of the vehicle 106. The view 102 indicates that the auto park is currently in process, and the vehicle 106 is being autonomously driven (in this example, in reverse) into a parking slot 700. That is, the parking slot 700 and optionally also one or more other parking slots were initially presented to the user in the view 102 (e.g., similar to the presentation of the parking slots 202-204 in FIG. 3). The user then selected the parking slot 700 for the autonomous parking maneuver. Motion path planning has been performed by an ADAS of the vehicle to determine a trajectory for bringing the vehicle 106 into the parking slot 700.

Lines 702 and 704 are here physical markings (e.g., paint) that indicate boundaries of the parking slot 700. The following are examples of one or more graphics that can be presented in the view 102 during the autonomous parking maneuver. Graphics 706 can indicate at least part of the trajectory for the vehicle 106. Graphics 708 can indicate a buffer zone relative to the vehicle 106 (e.g., based on signals from one or more ultrasonic sensors or another detector). Graphics 710 and 712 that are here schematically illustrated can indicate the presence of objects (e.g., another vehicle) near the vehicle 106 (e.g., based on signals from one or more ultrasonic sensors or other detector). Graphics 714 can be an end line regarding the autonomous parking maneuver. Other graphics can be used.

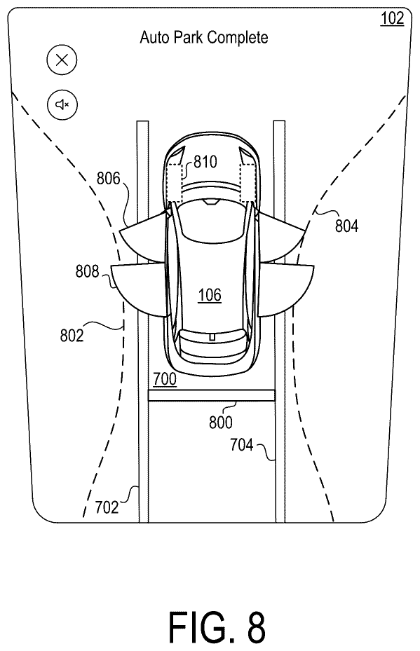

FIG. 8 shows an example of the autonomous parking maneuver having been completed. The lines 702 and 704, and a line 800 marking the end of the parking slot 700, are visible near the vehicle 106. The following are examples of one or more graphics that can be presented in the view 102 after completion of the autonomous parking maneuver. Graphics 802 and 804 that are here schematically illustrated can indicate the presence of objects (e.g., another vehicle) near the vehicle 106 (e.g., based on signals from one or more ultrasonic sensors or other detector). Graphics 806 and 808 can indicate a door swing path of the vehicle 106 (e.g., for a first-row door or a second-row door, respectively). For example, the graphics 806 and 808 can help the user ascertain how much room is available for opening the door(s). Graphics 810 can indicate a wheel position of one or more steerable wheels (e.g., one or more front wheels) of the vehicle 106. Other graphics can be used.

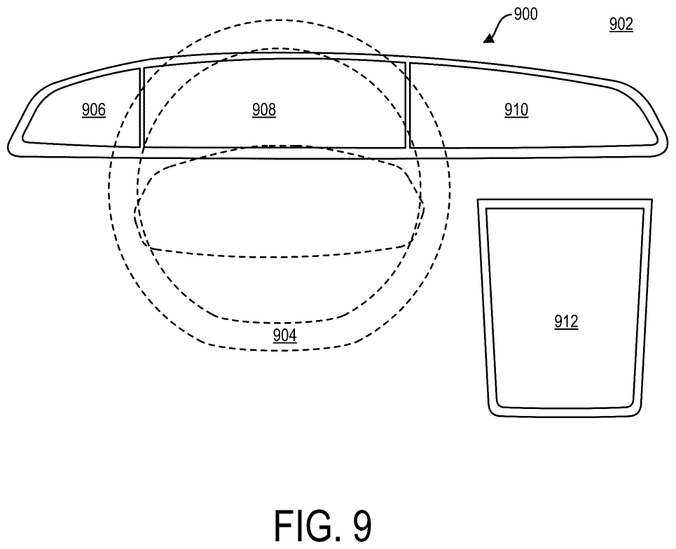

FIG. 9 shows an example of an instrument panel 900 of a vehicle 902. The vehicle 902 is mostly omitted in the present illustrations for simplicity. The vehicle 902 includes a steering wheel 904 (here shown in phantom for clarity), that can be used in connection with, or independently of, one or more controls or functions available at the instrument panel 900. In some implementations, the steering wheel 904 can include one or more buttons, scroll wheels, or other controls by which the driver can make at least one input. The instrument panel 900 can be used in combination with one or more other examples described elsewhere herein.

The instrument panel 900 includes a display device 906 here positioned somewhat to the left of the steering wheel 904. The instrument panel 900 includes a display device 908 here positioned essentially behind the steering wheel 904. The instrument panel 900 includes a display device 910 here positioned somewhat to the right of the steering wheel 904. The display device 910 can be horizontally aligned with an instrument cluster in the vehicle 902. For example, the instrument cluster can include at least the display device 908. The instrument panel 900 includes a display device 912 here positioned lower than (e.g., essentially vertically below) the display device 910. The display device 912 is considered to be positioned in the instrument panel 900. For example, the display device 912 can be positioned lower in the same physical housing in which the display devices 906, 908, and 910 are mounted. As another example, the display device 912 can be mounted in a center console positioned between first-row seats in the vehicle 902, so as to be reachable by the driver (and optionally a first-row passenger). Each of the display devices 906, 908, 910, and 912 can output any type of content. In some implementations, the views 100 and 102 (e.g., FIG. 1) can be presented on any or all of the display devices 906, 908, 910, and 912. For example, the view 100 can be presented on the display device 910, and the view 102 can be presented on the display device 912.

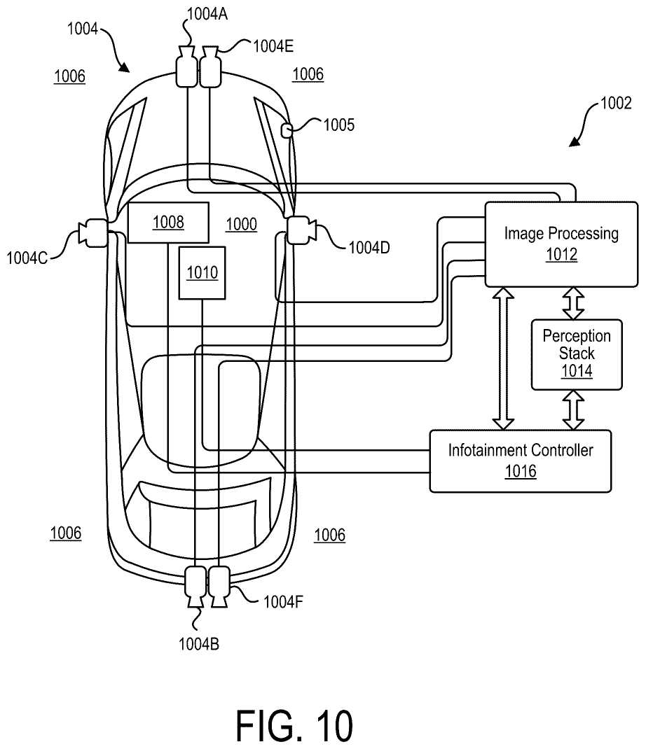

FIG. 10 shows an example of a vehicle 1000 with a system 1002 for performing SVM and autonomous parking. The system 1002 can be implemented inside the vehicle 1000 (e.g., to serve as part of its control circuitry) and is here shown separate from the vehicle 1000 for clarity. The vehicle 1000 and/or the system 1002 can be used with one or more other examples described elsewhere herein.

The vehicle 1000 can include one or more types of sensor. Here, the vehicle 1000 includes cameras 1004 that are schematically illustrated. In some implementations, the cameras 1004 can include multiple cameras distributed around the vehicle and directed towards surroundings 1006 of the vehicle. Any type(s) of image sensor that can capture the surroundings 1006 can be used as the camera(s) 1004. Any number of the cameras 1004 can be used. Here, SVM cameras of the system 1002 can include a camera 1004A positioned at the front of the vehicle 1000 and oriented forward, a camera 1004B positioned at the rear of the vehicle 1000 and oriented rearward, a camera 1004C positioned on the left side of the vehicle 1000 and oriented toward the left, and a camera 1004D positioned on the right side of the vehicle 1000 and oriented toward the right. The cameras 1004A-1004D can provide an SVM video feed for the vehicle 1000. and can have the same or different FOV as each other. For example, one or more of the cameras 1004A-1004D can be a so-called fisheye camera generating a fishbowl view. The cameras 1004 can also include a camera 1004E positioned at the front of the vehicle 1000 (e.g., at a front bumper) and oriented forward, and a camera 1004F positioned at the rear of the vehicle 1000 (e.g., at a decklid of the vehicle 1000) and oriented rearward. The sensors of the vehicle 1000 can include one or more ultrasonic sensors 1005 configured to detect nearby objects. While only a single instance of the ultrasonic sensor 1005 is shown here for simplicity, multiple instances of the ultrasonic sensor 1005 can be distributed around the vehicle 1000.

The vehicle 1000 can include one or more display devices that can be observed (and optionally interacted with) by a passenger. Here, the vehicle 1000 includes display devices 1008 and 1010. In some implementations, both of the display devices 1008-1010 are positioned in an instrument panel of the vehicle 1000. For example, the display device 1008 can form, or otherwise be aligned with, an instrument cluster in the vehicle 1000. As another example, the display device 1010 can be positioned at or aligned with a center console in the vehicle 1000.

The cameras 1004A-1004D can generate signals for an SVM video feed for the vehicle 1000. The signals of the cameras 1004A-1004D can be fed to an image processing component 1012 that can be implemented using features of FIG. yy below. As mentioned, the cameras 1004A-1004D can be fisheye cameras to generate the video feeds suitable for SVM. The image processing component 1012 can unwarp the feeds from the cameras 1004A-1004D and stitch together two or more of the feeds into a frame of the SVM video feed. As such, the stitched-together SVM video feed is a composite, so that perspectives like those in FIGS. 4-6 can be generated, in which the viewpoint is positioned some distance away from the vehicle, although the SVM cameras are all located on the vehicle. The SVM video frame can be used in at least two aspects of the system 1002, for example as will now be described.

The image processing component 1012 can provide the SVM video frame to a perception stack 1014 that can be implemented using features of FIG. yy below. The perception stack 1014 can be part of an ADAS and receive signals from some or all of the sensors of the vehicle 1000 (e.g., the cameras 1004, the ultrasonic sensor(s) 1005, and/or other sensors). The perception stack 1014 can perform object detection for objects near the vehicle 1000, localization of the vehicle 1000, sensor fusion of signals from two or more sensors, and tracking of objects near the vehicle 1000, to name just a few examples. Here, the perception stack 1014 can fuse the SVM video frame with ultrasonic signals to detect one or more parking slots. Referring again briefly to FIG. 2, the detection of the parking slot 202 can be done by determining the spatial coordinates thereof based on the SVM video feed, and verifying with the ultrasonic signals that there is no obstacle in the space defined by the coordinates. For example, the coordinates determined for the parking slot 202 can be the spatial coordinates defining a polygonal (e.g., rectangular) shape that essentially corresponds to the shape of the parking slot 202.

The image processing component 1012 can also provide the SVM video frame to an infotainment controller 1016 that can be implemented using features of FIG. yy below. The infotainment controller 1016 is configured for providing infotainment functionality in the vehicle 1000. The infotainment controller 1016 can generate video output to be presented on either or both of the display devices 1008 and 1010. The infotainment controller 1016 receives the SVM video frame so that an SVM video feed can be presented to the user.

The infotainment controller 1016 or the image processing component 1012 can overlay one or more graphics on the SVM video frame to assist the user of the vehicle 1000. Any or all of the graphics described elsewhere herein can be overlaid on the SVM video frame. For example, the graphics 300 and/or 302 of FIG. 3 can be overlaid on the parking slot 202 or 204, respectively, based on determination of the coordinates of the parking slot. Graphics relating to autonomous control of the vehicle 1000 can also or instead be overlaid on the SVM video frame. For example, the system 1002 can interface with, or include, an ADAS of the vehicle 1000 and thereby obtain motion path planning information regarding a trajectory that has been defined for an autonomous parking maneuver of the vehicle 1000. One or more graphics can then be overlaid on the video feed based on such trajectory.

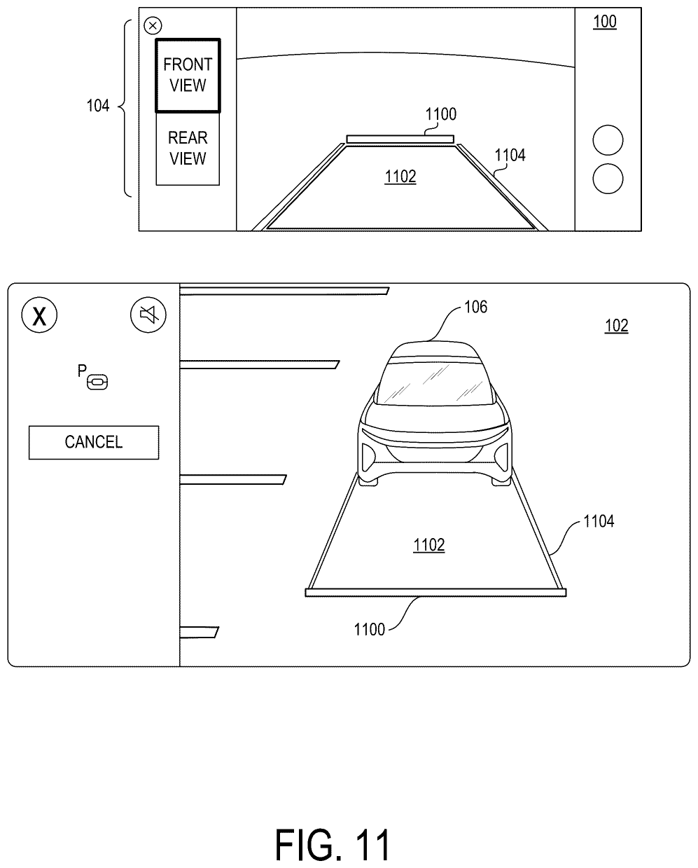

FIG. 11 shows an example of contextual views. The system that integrates auto park functionality into an SVM video feed can provide contextual views during the autonomous parking maneuver to better assist the user. The contextual views can facilitate that the SVM video feed is at all times presented using the perspective that is the most helpful or relevant to the user. For example, the contextual views can depend on a gear change of the vehicle. Here, the view 100 has been set, by automatic activation of the touchscreen input control 104, to present a front view while the vehicle is in forward motion. For example, the front view can include video feed from the camera 1004E (FIG. 10). One or more graphics can be overlaid on the video feed. Graphics 1100 can be an end line regarding a portion of the autonomous parking maneuver. Graphics 1102 can be a carpet that indicates the extent of a trajectory of the autonomous parking maneuver. Graphics 1104 can be a line that indicates the boundary of a trajectory of the autonomous parking maneuver.

In this example, the view 102 is shown with a somewhat different aspect ratio than before. For example, the aspect ratio can be chosen based on the display device(s) available in the particular vehicle. The view 102 has been set, as a contextual view during an autonomous parking maneuver, to show the vehicle 106 from the front (i.e., traveling toward the observer). One or more graphics can be overlaid on the video feed. The graphic 1100 (e.g., end line), the graphic 1102 (e.g., carpet) and the graphic 1104 (e.g., boundary) are here shown as examples of what can be overlaid on the video feed. The contextual view can continue until the system decides to change into a different contextual view or until the autonomous parking maneuver is completed. For example, the change can be triggered by a gear change of the vehicle 106 during the autonomous parking maneuver.

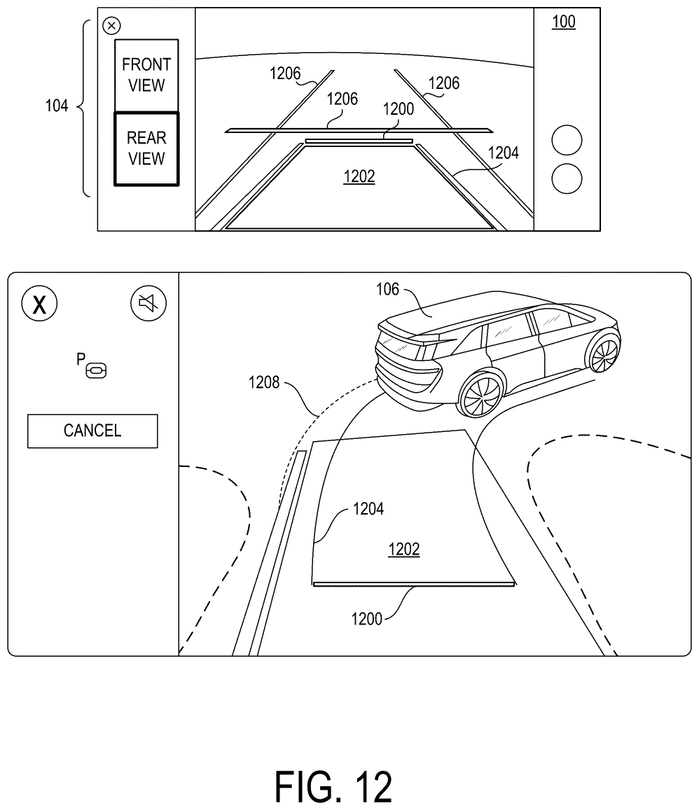

FIG. 12 shows another example of contextual views. Here, the view 100 has been set, by automatic activation of the touchscreen input control 104, to present a rear view while the vehicle is in rearward motion. For example, the rear view can include video feed from the camera 1004F (FIG. 10). One or more graphics can be overlaid on the video feed. Graphics 1200 can be an end line regarding an aspect of the autonomous parking maneuver. Graphics 1202 can be a carpet that indicates the extent of a trajectory of the autonomous parking maneuver. Graphics 1204 can be a line that indicates the boundary of a trajectory of the autonomous parking maneuver. Lines 1206, on the other hand, can be physical markings (e.g., paint) that define the parking slot.

The view 102 has been set, as a contextual view during an autonomous parking maneuver, to show the vehicle 106 from the rear (i.e., traveling toward the observer). One or more graphics can be overlaid on the video feed. The graphic 1200 (e.g., end line), the graphic 1202 (e.g., carpet), the graphic 1204 (e.g., boundary) and a graphic 1208 (e.g., a trajectory line) are here shown as examples of what can be overlaid on the video feed. The contextual view can continue until the system decides to change into a different contextual view or until the autonomous parking maneuver is completed.

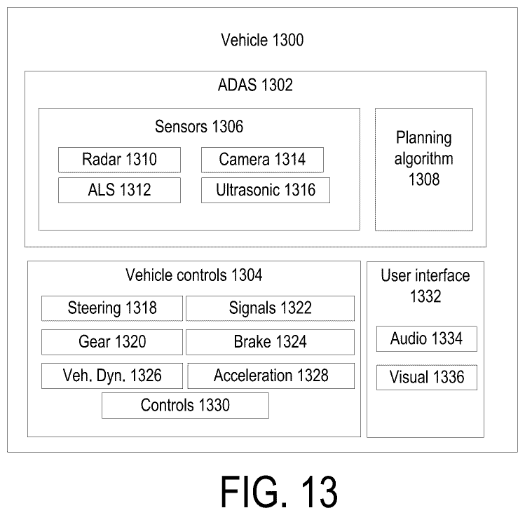

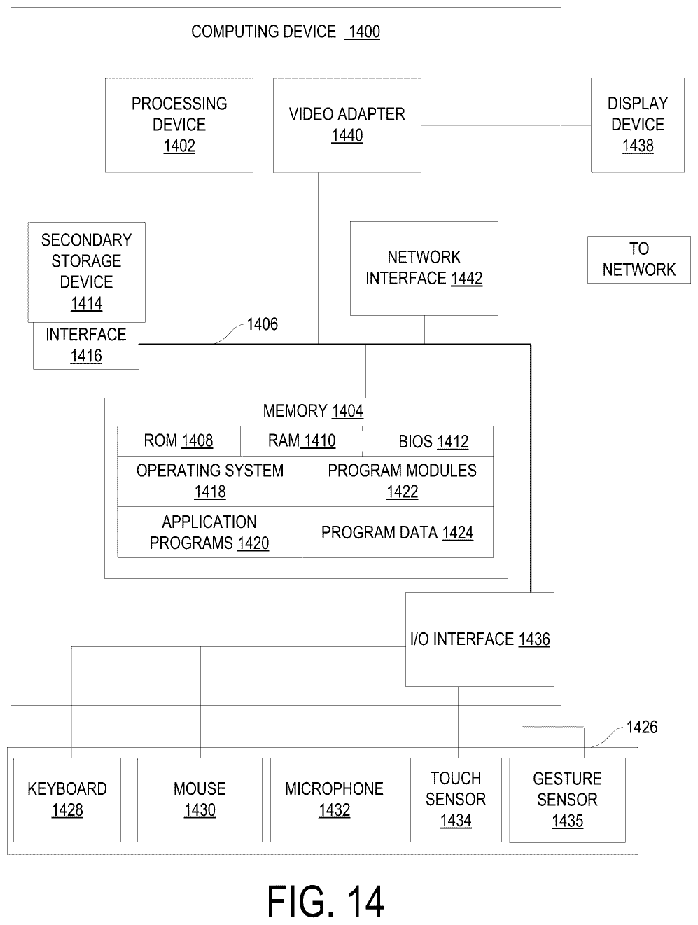

FIG. 13 shows another example of a vehicle 1300. The vehicle 1300 can be used with one or more other examples described elsewhere herein. The vehicle 1300 includes an ADAS 1302 and vehicle controls 1304. The ADAS 1302 includes sensors 1306 and a planning algorithm 1308. Other aspects that the vehicle 1300 may include, including, but not limited to, other components of the vehicle 1300 where the ADAS 1302 may be implemented, are omitted here for simplicity.

The sensors 1306 are here described as also including appropriate circuitry and/or executable programming for processing sensor output and performing a detection based on the processing. The sensors 1306 can include a radar 1310. In some implementations, the radar 1310 can include any object detection system that is based at least in part on radio waves. For example, the radar 1310 can be oriented in a forward direction relative to the vehicle and can be used for detecting at least a distance to one or more other objects (e.g., another vehicle). The radar 1310 can detect the surroundings of the vehicle 1300 by sensing the presence of an object in relation to the vehicle 1300.

The sensors 1306 can include an active light sensor 1312. In some implementations, the active light sensor 1312 can include any object detection system that is based at least in part on laser light or LED light. For example, the active light sensor 1312 can include a LiDAR. The active light sensor 1312 can be oriented in any direction relative to the vehicle and can be used for detecting at least a distance to one or more other objects (e.g., another vehicle). The active light sensor 1312 can detect the surroundings of the vehicle 1300 by sensing the presence of an object in relation to the vehicle 1300.

The sensors 1306 can include one or more cameras 1314. In some implementations, the cameras 1314 can include any image sensor whose signal(s) the vehicle 1300 takes into account. For example, the cameras 1314 can be oriented in any of multiple directions relative to the vehicle and can be used for detecting vehicles or other objects, lanes, lane markings, curbs, and/or road signage. The cameras 1004 (FIG. 10) are examples of the cameras 1314.

The sensors 1306 can include an ultrasonic sensor 1316. The ultrasonic sensor 1316 can include any device that determines location based on generating and detecting sound waves.

Any of the sensors 1306 alone, or two or more of the sensors 1306 collectively, can detect, whether or not the ADAS 1302 is controlling motion of the vehicle 1300, the surroundings of the vehicle 1300. For example, the output of two or more sensors can be combined. In some implementations, one or more other types of sensors can additionally or instead be included in the sensors 1306. The ADAS 1302 can perform motion planning and/or plan a trajectory for the vehicle 1300 (e.g., for an autonomous parking maneuver) based on the output(s) of one or more of the sensors 1306.

The vehicle controls 1304 can include a steering control 1318. In some implementations, the ADAS 1302 and/or another driver of the vehicle 1300 controls the trajectory of the vehicle 1300 by adjusting a steering angle of at least one wheel by way of manipulating the steering control 1318. The steering control 1318 can be configured for controlling the steering angle though a mechanical connection between the steering control 1318 and the adjustable wheel, or can be part of a steer-by-wire system.

The vehicle controls 1304 can include a gear control 1320. In some implementations, the ADAS 1302 and/or another driver of the vehicle 1300 uses the gear control 1320 to choose from among multiple operating modes of a vehicle (e.g., a Drive mode, a Neutral mode, or a Park mode). For example, the gear control 1320 can be used to control an automatic transmission in the vehicle 1300.

The vehicle controls 1304 can include signal controls 1322. In some implementations, the signal controls 1322 can control one or more signals that the vehicle 1300 can generate. For example, the signal controls 1322 can control a turn signal and/or a horn of the vehicle 1300.

The vehicle controls 1304 can include brake controls 1324. In some implementations, the brake controls 1324 can control one or more types of braking systems designed to slow down the vehicle, stop the vehicle, and/or maintain the vehicle at a standstill when stopped. For example, the brake controls 1324 can be actuated by the ADAS 1302. As another example, the brake controls 1324 can be actuated by the driver using a brake pedal.

The vehicle controls 1304 can include a vehicle dynamic system 1326. In some implementations, the vehicle dynamic system 1326 can control one or more functions of the vehicle 1300 in addition to, or in the absence of, or in lieu of, the driver's control. For example, when the vehicle comes to a stop on a hill, the vehicle dynamic system 1326 can hold the vehicle at standstill if the driver does not activate the brake control 1324 (e.g., step on the brake pedal).

The vehicle controls 1304 can include an acceleration control 1328. In some implementations, the acceleration control 1328 can control one or more types of propulsion motor of the vehicle. For example, the acceleration control 1328 can control the electric motor(s) and/or the internal-combustion motor(s) of the vehicle 1300.

The vehicle controls 1304 can include one or more other controls 1330 in addition to those exemplified above.

The vehicle 1300 can include a user interface 1332. The user interface 1332 can include an audio interface 1334. In some implementations, the audio interface 1334 can include one or more speakers positioned in the passenger compartment. For example, the audio interface 1334 can at least in part operate together with an infotainment system in the vehicle.

The user interface 1332 can include a visual interface 1336. In some implementations, the visual interface 1336 can include at least one display device in the passenger compartment of the vehicle 1300. In some implementations, the visual interface 1336 can include a touchscreen device and/or an instrument cluster display. For example, any display device mentioned elsewhere herein is an example of the visual interface 1336.

Computer-based techniques, processes, components, or systems described herein can be implemented by way of one or more processors executing instructions stored in a non-transitory computer-readable medium.

FIG. yy illustrates an example architecture of a computing device yy00 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. yy can be used to execute the operating system, application programs, and/or software modules (including the software engines) described herein.

The computing device yy00 includes, in some embodiments, at least one processing device yy02 (e.g., a processor), such as a central processing unit (CPU). A variety of processing devices are available from a variety of manufacturers, for example, Intel or Advanced Micro Devices. In this example, the computing device yy00 also includes a system memory yy04, and a system bus yy06 that couples various system components including the system memory yy04 to the processing device yy02. The system bus yy06 is one of any number of types of bus structures that can be used, including, but not limited to, a memory bus, or memory controller; a peripheral bus; and a local bus using any of a variety of bus architectures.

Examples of computing devices that can be implemented using the computing device yy00 include a desktop computer, a laptop computer, a tablet computer, a mobile computing device (such as a smart phone, a touchpad mobile digital device, or other mobile devices), or other devices configured to process digital instructions.

The system memory yy04 includes read only memory yy08 and random access memory yy 10. A basic input/output system yy12 containing the basic routines that act to transfer information within computing device yy00, such as during start up, can be stored in the read only memory yy08.

The computing device yy00 also includes a secondary storage device yy14 in some embodiments, such as a hard disk drive, for storing digital data. The secondary storage device yy14 is connected to the system bus yy06 by a secondary storage interface yy16. The secondary storage device yy14 and its associated computer readable media provide nonvolatile and non-transitory storage of computer readable instructions (including application programs and program modules), data structures, and other data for the computing device yy00.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device yy14 and/or system memory yy04, including an operating system yy18, one or more application programs yy20, other program modules yy22 (such as the software engines described herein), and program data yy24. The computing device yy00 can utilize any suitable operating system.

In some embodiments, a user provides inputs to the computing device yy00through one or more input devices yy26. Examples of input devices yy26 include a keyboard yy28, mouse yy30, microphone yy32 (e.g., for voice and/or other audio input), touch sensor yy34 (such as a touchpad or touch sensitive display), and gesture sensor yy35 (e.g., for gestural input). In some implementations, the input device(s) yy26 provide detection based on presence, proximity, and/or motion. Other embodiments include other input devices yy26. The input devices can be connected to the processing device yy02 through an input/output interface yy36 that is coupled to the system bus yy06. These input devices yy26 can be connected by any number of input/output interfaces, such as a parallel port, serial port, game port, or a universal serial bus. Wireless communication between input devices yy26 and the input/output interface yy36 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device yy38, such as a monitor, liquid crystal display device, light-emitting diode display device, projector, or touch sensitive display device, is also connected to the system bus yy06 via an interface, such as a video adapter yy40. In addition to the display device yy38, the computing device yy00 can include various other peripheral devices (not shown), such as speakers or a printer.

The computing device yy00 can be connected to one or more networks through a network interface yy42. The network interface yy42 can provide for wired and/or wireless communication. In some implementations, the network interface yy42 can include one or more antennas for transmitting and/or receiving wireless signals. When used in a local area networking environment or a wide area networking environment (such as the Internet), the network interface yy42 can include an Ethernet interface. Other possible embodiments use other communication devices. For example, some embodiments of the computing device yy00 include a modem for communicating across the network.

The computing device yy00 can include at least some form of computer readable media. Computer readable media includes any available media that can be accessed by the computing device yy00. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device yy00.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. yy is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device yy00 can be characterized as an ADAS computer. For example, the computing device yy00 can include one or more components sometimes used for processing tasks that occur in the field of artificial intelligence (AI). The computing device yy00 then includes sufficient proceeding power and necessary support architecture for the demands of ADAS or AI in general. For example, the processing device yy02can include a multicore architecture. As another example, the computing device yy00 can include one or more co-processors in addition to, or as part of, the processing device yy02. In some implementations, at least one hardware accelerator can be coupled to the system bus yy06. For example, a graphics processing unit can be used. In some implementations, the computing device yy00 can implement a neural network-specific hardware to handle one or more ADAS tasks.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.” It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
receiving a surround view monitoring (SVM) video feed from SVM cameras of a vehicle;
identifying, using the SVM video feed and a signal from one or more ultrasonic sensors of the vehicle, a first parking slot that is available for parking the vehicle, the first parking slot associated with coordinates;
overlaying, using the coordinates of the first parking slot, a first graphic on the SVM video feed to generate an augmented SVM video feed, the first graphic representing the first parking slot; and
presenting the augmented SVM video feed including the graphic on a display device of the vehicle, wherein the first graphic is selectable by a user to trigger an autonomous parking maneuver of the vehicle into the first parking slot, and wherein the augmented SVM video feed facilitates freeform perspective change by the user.

2. The method of claim 1, wherein the SVM cameras generate fishbowl views, the method further comprising unwarping the SVM video feed and performing stitching to generate frames of the SVM feed.

3. The method of claim 1, further comprising performing the autonomous parking maneuver in response to the user selecting the first graphic.

4. The method of claim 3, wherein also a second parking slot is identified using the SVM video feed and the signal from the one or more ultrasonic sensors.

5. The method of claim 4, further comprising overlaying also a second graphic on the SVM video feed to generate the augmented SVM video feed, the second graphic representing the second parking slot, wherein the second graphic is selectable by the user to trigger the autonomous parking maneuver of the vehicle into the second parking slot.

6. The method of claim 5, further comprising removing the second graphic from the augmented SVM video feed in response to the user selecting the first graphic.

7. The method of claim 4, further comprising prioritizing, before overlaying the first graphic on the SVM video feed, the first parking slot over the second parking slot, wherein as a result the second parking slot is not presented to the user.

8. The method of claim 3, further comprising overlaying also a motion path graphic on the SVM video feed to generate the augmented SVM video feed.

9. The method of claim 8, wherein the motion path graphic includes an end line regarding the autonomous parking maneuver.

10. The method of claim 8, wherein the motion path graphic indicates a trajectory of the autonomous parking maneuver.

11. The method of claim 3, further comprising, at an end of the autonomous parking maneuver, overlaying also a third graphic on the SVM video feed to generate the augmented SVM video feed, the third graphic representing at least one of a door swing path of travel for the vehicle, or a wheel position of the vehicle.

12. The method of claim 3, further comprising presenting a control for the user to choose whether the vehicle enters the first parking slot front-first or rear-first in the autonomous parking maneuver.

13. The method of claim 1, further comprising overlaying also a vehicle graphic on the SVM video feed to generate the augmented SVM video feed, the vehicle graphic representing the vehicle.

14. The method of claim 1, further comprising automatically providing, during the autonomous parking maneuver, contextual views using the freeform perspective change, the contextual views depending on gear change of the vehicle.

15. The method of claim 1, wherein the first graphic is a rectangle corresponding to the first parking slot.

16. The method of claim 1, wherein the first graphic is a symbol representing the first parking slot.

17. A non-transitory computer-readable medium including instructions that when executed cause a processor to perform operations, the operations comprising:
receiving a surround view monitoring (SVM) video feed from SVM cameras of a vehicle;
identifying, using the SVM video feed and a signal from one or more ultrasonic sensors of the vehicle, a first parking slot that is available for parking the vehicle, the first parking slot associated with coordinates;
overlaying, using the coordinates of the first parking slot, a first graphic on the SVM video feed to generate an augmented SVM video feed, the first graphic representing the first parking slot; and
presenting the augmented SVM video feed including the graphic on a display device of the vehicle, wherein the first graphic is selectable by a user to trigger an autonomous parking maneuver of the vehicle into the first parking slot, and wherein the augmented SVM video feed facilitates freeform perspective change by the user.

18. A non-transitory computer-readable medium including instructions that when executed cause a processor to generate a graphical user interface (GUI) for a vehicle, the GUI presented on a display device of the vehicle and comprising:
an augmented surround view monitoring (SVM) video feed based on an SVM video feed from SVM cameras of the vehicle, the augmented SVM video feed including a first graphic representing a first parking slot that is available for parking the vehicle, the first parking slot identified using the SVM video feed and a signal from one or more ultrasonic sensors of the vehicle, wherein the first graphic is selectable by a user to trigger an autonomous parking maneuver of the vehicle into the first parking slot, and wherein the augmented SVM video feed facilitates freeform perspective change by the user.

19. The non-transitory computer-readable medium of claim 18, wherein also a second parking slot is identified using the SVM video feed and the signal from the one or more ultrasonic sensors, and wherein also a second graphic on the SVM video feed to generate the augmented SVM video feed, the second graphic representing the second parking slot, wherein the second graphic is selectable by the user to trigger the autonomous parking maneuver of the vehicle into the second parking slot.

20. The non-transitory computer-readable medium of claim 18, wherein the GUI automatically provides contextual views using the freeform perspective change, the contextual views depending on gear change of the vehicle.
